(19) United States
(12) Patent Application Publication
(10) Pub. No.: US 2016/0305557 A1
(43) Pub. Date: Oct. 20, 2016

(54) ROTARY SWITCH VALVE CORE

(71) Applicant: Xiamen Runner Industrial Corporation, Xiamen (CN)

(72) Inventors: Hui-Ming Liu, Xiamen (CN); Feng Lin, Xiamen (CN)

(21) Appl. No.: 15/096,264

(22) Filed: Apr. 11, 2016

(30) Foreign Application Priority Data
Apr. 18, 2015 (CN) 201520238160.X

(51) Int. Cl. F16K 11/074

(52) U.S. Cl. CPC F16K 11/074

(57) ABSTRACT

A rotary switch valve core includes a housing, a base, a cold inlet hole, a hot inlet hole, a filtered hole, a mixed outlet hole, a rotary stem, a rotary lid, a rotary tile, a stationary tile, a first collar seal and a second collar seal. The base is mounted on a bottom of the housing and has a cold inlet hole, a hot inlet hole, a filtered hole, and a mixed outlet hole formed through the base and communicating with the four guide holes of the stationary tile. A slot is centrally formed in an inner surface of the rotary tile. The rotary switch valve core controls filtered water or running water outlet from an outlet pipe. The rotary switch valve core ensures simple structure, convenient operation and multiple water output modes.

### BACKGROUND OF THE INVENTION

1. Field of the Invention

The present invention relates a rotary switch valve core and, more particularly, to control different waterways in the outlet pipe.

2. Description of the Related Art

Now the space for people to live in their daily life is getting less. However, there are usually two types of faucets in the kitchen, one for filtered water and one for regular running water. It takes more space in kitchen and inconvenience therefore arises.

Furthermore, the purification device having high water press of the water supply system for supply water. To avoid the purification device, get damage of high water press, between the purification device and the water supply system mounted a switch to control water on and off is necessary.

Here are some conventional techniques disclosing different types of valve core of faucets. A first technique involves a double-water-outlet valve core. However, installation of the valve core needed multiple seal to seal up, not only more space, but also higher cost is the concern, and to reduce airtightness of the valve core. A second technique discloses a double-water-outlet water mixing valve element. There are only two water outlet types of the mixing valve element, even two types water having same temperature. The mixing valve element is more suitable for take a shower.

For economizing space and materials, how to combine running water and filtered water on a valve core is the subject to be explored.

### SUMMARY OF THE INVENTION

In view of the problems and drawbacks of the conventional techniques, the objective of the present invention is to provide a rotary switch valve core ensuring multiple types of water output.

To achieve the foregoing objective, the rotary switch valve core includes a housing, a base, a cold inlet hole, a hot inlet hole, a filtered hole, a mixed outlet hole, a rotary stem, a rotary lid, a rotary tile, a stationary tile, a first collar seal and, a second collar seal.

The housing being cylindrical and having a top opening and a bottom opening.

The rotary stem mounted inside the housing, protruding beyond the top opening of the housing.

The rotary tile mounted inside the housing and having a slot centrally formed in an inner surface of the rotary tile, and multiple notches formed around an edge portion of a top surface of the rotary tile, and engaging the respective bumps of the rotary stem.

The rotary lid mounted between the rotary stem and the rotary tile.

The stationary tile having four guide holes.

The base mounted on a bottom of the housing and having a cold inlet hole, a hot inlet hole, a filtered hole, and a mixed outlet hole formed through the base and communicating with the four guide holes of the stationary tile.

According to the foregoing description, the present invention has the advantages of a simplified structure to made multiple difference waterway gather to one inlet channel is convenience to used, and reduced water path and faucet size.

### BRIEF DESCRIPTION OF THE DRAWINGS

The detailed description of the drawings particularly refers to the accompanying figures in which:

FIG. 1 is an exploded perspective view of a rotary switch valve core;

FIG. 2 is a perspective view of a base of the rotary switch valve core in FIG. 1;

FIG. 3 is a perspective view of button end of a movable tile in FIG. 1;

FIG. 4 is a cross-sectional view of the rotary switch valve core in FIG. 1;

FIGS. 5A-5E are an operational views of the movable tile and a stationary tile in FIG. 1; and

FIG. 6 is an operational view illustrating five rotation angles between the movable tile and the stationary tile of the rotary switch valve core in FIG. 1.

### DETAILED DESCRIPTION OF THE INVENTION

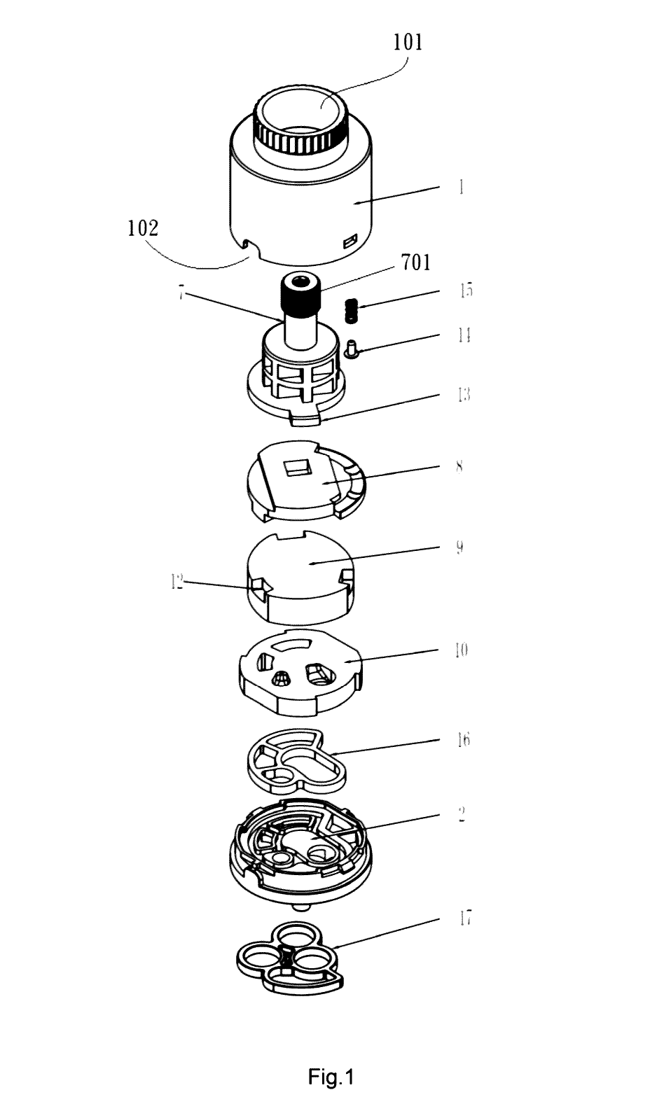

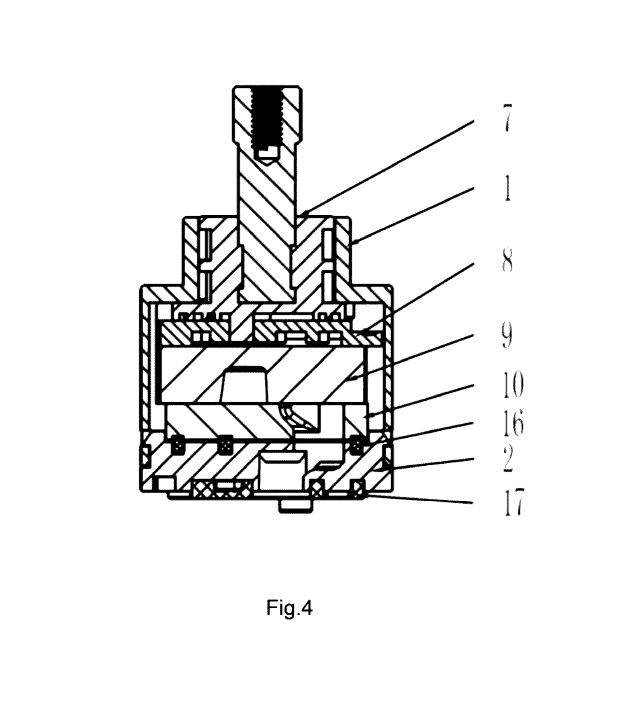

As shown in FIGS. 1-6, the purpose, construction, features, functions and advantages of the present invention can be appreciated and understood more thoroughly through the following detailed description with reference to the attached drawings.

With reference to FIGS. 1 to 6, a rotary switch valve core with the present invention includes a housing 1, a base 2, a cold inlet hole 3, a hot inlet hole 4, a filtered hole 5, a mixed outlet hole 6, a rotary stem 7, a rotary lid 8, a rotary tile 9, a stationary tile 10, a first collar seal 16 and, a second collar seal 17. The rotary switch valve core is mounted between an outlet of a handle and a faucet, and to drive differently water flows out.

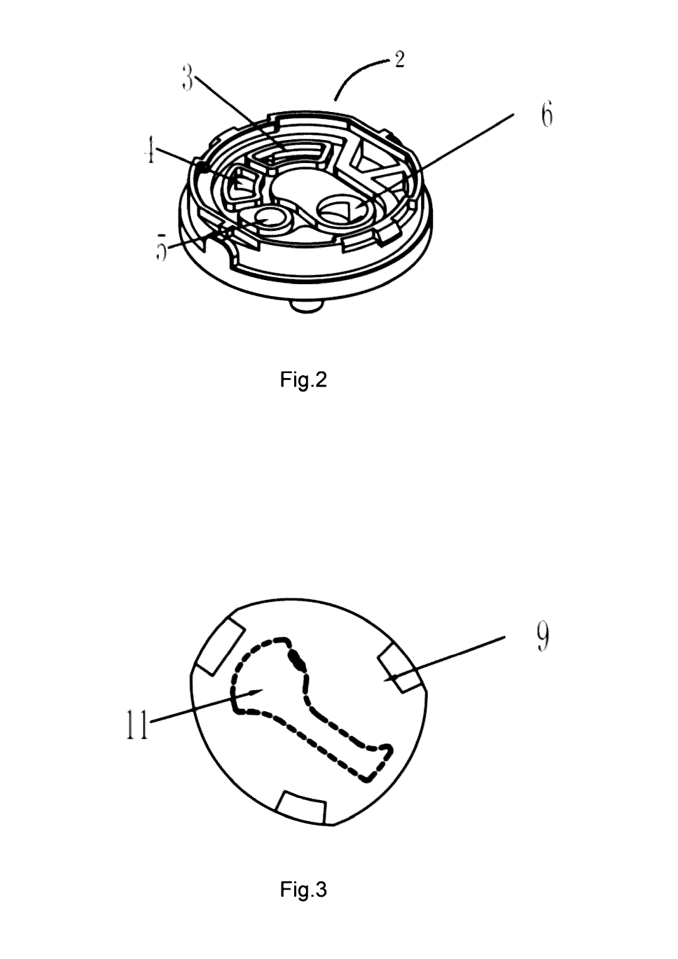

The housing 1 is cylindrical has a top opening 101 and a bottom opening 102. With reference to FIGS. 1 and 2, the base 2 is mounted on a bottom of the housing 1, and the cold inlet hole 3, the hot inlet hole 4, the filtered hole 5 and the mixed outlet hole 6 are formed through the base 2. The cold inlet hole 3, the hot inlet hole 4, the filtered hole 5 and the mixed outlet hole 6 are selectively communicates with an outlet of five conduits.

Tap water and hot water enters through the cold inlet hole 3 and the hot inlet hole 4. The rotary stem 7, the rotary lid 8, the rotary tile 9 and the stationary tile 10 are sequentially mounted inside the housing 1. The rotary stem 7 protrudes beyond a top opening 101 of the housing 1. The rotary stem 7 has a connecter 701 and multiple bumps 13. The connecter 701 is formed on an outer end of the rotary stem 7. The multiple bumps 13 are formed around and protrude radially from a perimeter of a bottom surface of the rotary stem 7 and are spaced apart from each other by gaps. The rotary lid 8 is mounted on the housing 1, is securely connected with a bolt 14 and a spring 15, and the bolt 14 is connected with an inner wall of the housing.

With reference to FIGS. 1 to 4, the rotary tile 9 has multiple notches 12 formed around an edge portion of a top surface of the rotary tile 9 and engaging the respective bumps 13 of the rotary stem 7, and the rotary lid 8 is mounted between the rotary stem 7 and the rotary tile 9.

With reference to FIGS. 1 and 2, the stationary tile 10 has four guide holes respectively communicating with the cold inlet hole 3, the hot inlet hole 4, the filtered hole 5 and the mixed outlet hole 6 of the base 2.

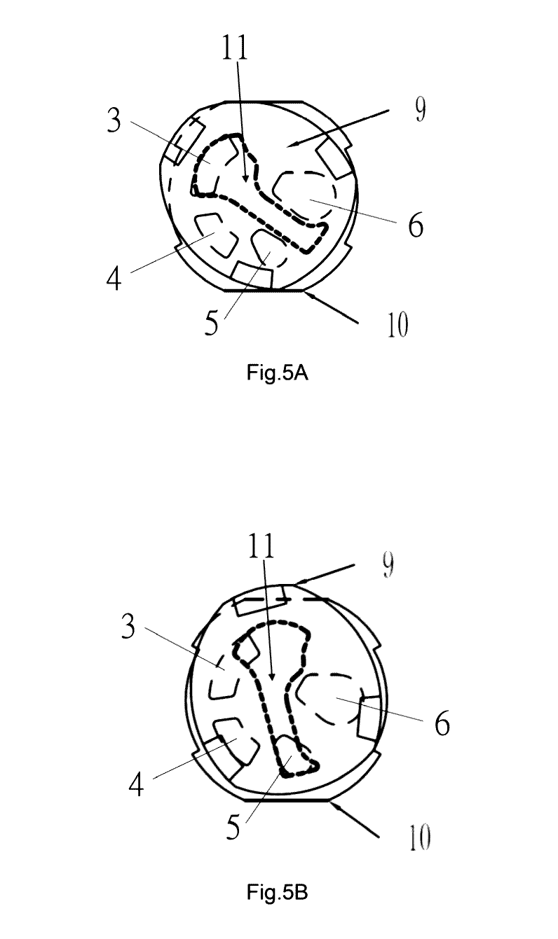

With reference to FIG. 4, a first collar seal 16 and a second collar seal 17 are respectively mounted in an outer surface and an inner surface of the base 2 to form hermetic seal among the stationary tile 10 and the base 2.

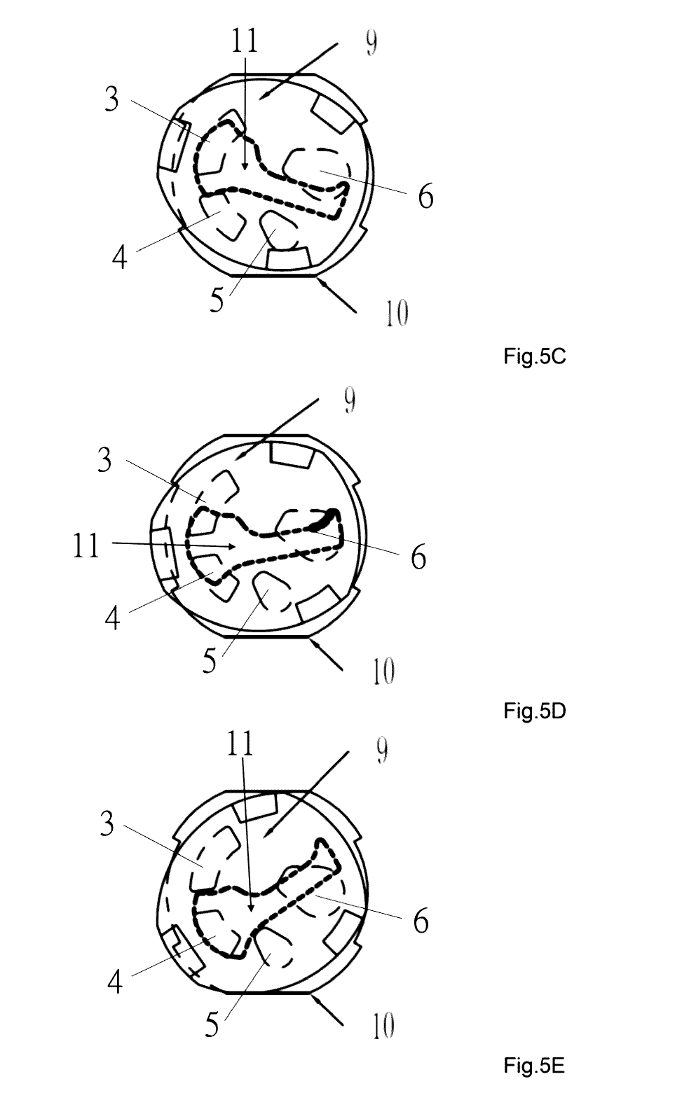

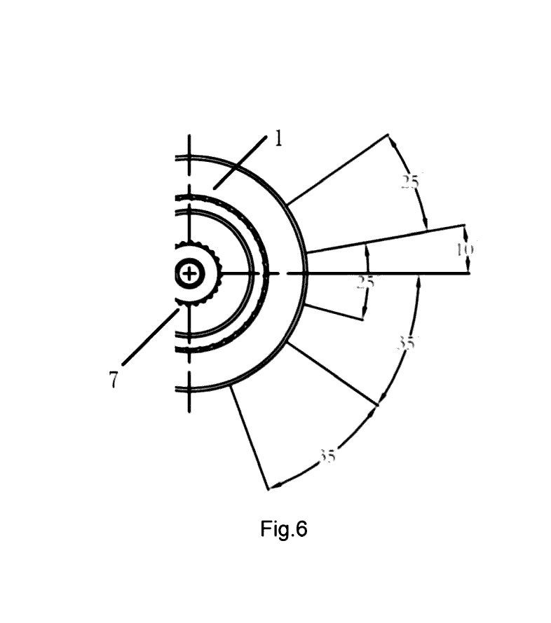

With reference FIGS. 5A to 5E and 6, to achieve arbitrary switch of different kinds of water, the operation is described as follow.

FIG. 5A shows a closed position. At the closed position, a portion of the slot 11 of the rotary tile 9 communicates with the cold inlet hole 3 while the remaining portion of the slot 11 fails to communicate with none of the cold inlet hole 3, the hot inlet hole 4, the filtered hole 5, and the mixed outlet hole 6. Therefore, no water will not flow out.

FIG. 5B shows a filtered water position. At the filtered water position, the handle is turned 35° in a clockwise direction, a portion of the slot 11 communicates with the cold inlet hole 3 while another portion of the slot 11 communicates with the filtered hole 5. Therefore, water to be filtered flows to the purification device through a filtered water conduit and water filtered by the water purification device flows through the inner channel of an outlet pipe.

FIG. 5C shows a cold water position. At the cold water position, the handle is turned 15° in a counterclockwise direction, a portion of the slot 11 communicates with the cold inlet hole 3 and another portion of the slot 11 communicates with the mixed outlet hole 6. Therefore, cold water enters the cold inlet hole 3 through the cold water inlet conduit 4 and then flows to the mixed outlet hole 6 through the slot 11, and further flows out of the outer channel of the outlet pipe.

FIG. 5D shows a warm water position (half cold and half hot) At the warm water position, the handle is turned 45° in the counterclockwise direction. A portion of the slot 11 communicates with the cold inlet hole 3 and the hot inlet hole 4, and another portion of the slot 11 communicates with the mixed outlet hole 6. Therefore, hot water and cold water respectively flows to the hot inlet hole 4 and the cold inlet hole 3 of the rotary switch valve core through a hot water inlet conduit and a cold water inlet conduit then flows to the mixed outlet hole 6 through the slot 11, and further flows out of the outer channel of the outlet pipe.

FIG. 5E shows a hot water position. At the hot water position, the handle is turned 70° in the counterclockwise direction. A portion of the slot 11 communicates with the hot inlet hole 4, and another portion of the slot 11 communicates with the mixed outlet hole 6. Therefore, hot water enters the cold inlet hole 4 of the rotary switch valve core through the hot water inlet conduit, then flows to the mixed outlet hole 6 through the slot 11, and further flows out of the outer channel of the outlet pipe.

What is claimed is:

1. A rotary switch valve core comprising:
a housing being cylindrical and having a top opening and a bottom opening;
a rotary stem mounted inside the housing, protruding beyond the top opening of the housing, and having:
a connector formed on an outer end of the rotary stem and engaging an inner portion of the knob through splined connection; and
multiple bumps formed around and protruding radially from a perimeter of a bottom surface of the rotary stem, and spaced apart from each other by gaps;
a rotary tile mounted inside the housing and having a slot centrally formed in an inner surface of the rotary tile;
a rotary lid mounted between the rotary stem and the rotary tile;
a stationary tile having four guide holes; and
a base mounted on a bottom of the housing and having a cold inlet hole, a hot inlet hole, a filtered hole, and a mixed outlet hole formed through the base and communicating with the four guide holes of the stationary tile.

2. The rotary switch valve core as claimed in claim 1, wherein multiple notches formed around an edge portion of a top surface of the rotary tile, and engaging the respective bumps of the rotary stem.

3. The rotary switch valve core as claimed in claim 1, wherein a bolt and a spring are mounted in an inner wall of the housing to connect with the rotary lid.

4. The rotary switch valve core as claimed in claim 1, wherein a first collar seal and a second collar seal are respectively mounted in an outer surface and an inner surface of the base to formed hermetic seal among the stationary tile and the base.
